(19) United States
(12) Patent Application Publication
(10) Pub. No.: US 2026/0125931 A1
(43) Pub. Date: May 7, 2026

(54) HOME APPLIANCE DOOR LOCK DEVICE

(71) Applicant: DUE POWER ELECTRONICS CO., LTD, Jeongeup-si (KR)

(72) Inventors: Jang-Joo LIM, Seoul (KR); Sang-Won Suh, Jeongeup-si (KR); Jung Gil Lee, Jeongeup-si (KR); Hee Chang Kim, Jeongeup-si (KR)

(21) Appl. No.: 19/403,683

(22) Filed: Nov. 28, 2025

Related U.S. Application Data
(63) Continuation of application No. PCT/KR2024/003402, filed on Mar. 19, 2024.

(30) Foreign Application Priority Data
Jun. 14, 2023 (KR) 10-2023-0076202

(51) Int. Cl. E05B 47/00; E05B 65/00

(52) U.S. Cl. CPC E05B 47/0012; E05B 65/00; E05B 2047/0016; E05B 2047/0017; E05B 2047/002

(57) ABSTRACT

door lock device comprising a main body cover in which a space is formed and a motor installed inside the main body cover to provide driving force, according to an embodiment of the present invention, includes a locker, a locker shaft, a rack slide, a pinion gear, a damper, a side plate, a release cam, a release elastic member, a rotary, and a bridge, wherein the side plate comprises a first movement track for inducing up-down and left-right movement of the locker shaft and the release cam includes, on one side surface or the other side surface thereof, a second movement track for inducing left-right movement of the locker shaft.

### CROSS-REFERENCE TO RELATED APPLICATION(S)

This present application is a continuation of International Patent Application No. PCT/KR2024/003402, filed on Mar. 19, 2024, which is based upon and claims the benefit of priority to Korean Patent Application No. 10-2023-0076202 filed on Jun. 14, 2023. The disclosures of the above-listed applications are hereby incorporated by reference herein in there entirety.

### TECHNICAL FIELD

The present invention relates to a door lock device for home appliances, and more particularly, to a door lock device mounted on washing machines, dryers, and the like.

### RELATED ART

Various home appliances exist in daily life. In particular, washing machines, dryers, dishwashers, microwave ovens, and the like, which are used by loading contents, are equipped with doors so that the loaded contents can be isolated from the outside, and a locking device for opening and closing the door is an essential component constituting the home appliance.

Various technologies related to door lock devices have been developed until recently. Representative inventions include Korean Patent Registration No. 10-1667916 (Push and Push Door Lock Device), Korean Patent Registration No. 10-1915250 (Manual Door Lock Device), and the like.

The push and push door lock device discloses a door lock device in which the door is automatically opened without the user opening the door when the operation of the home appliance is completed. The push and push door lock device is installed inside the main body and includes a driving unit that selectively controls door holding, door locking, and automatic door opening operations by a release button that releases the restraining force of a fixing member by a sliding operation to release the locking of the locker, and by a rotation operation of a rotating shaft provided with a cam protrusion on one side.

Unlike the conventional method operated electronically by a solenoid, the manual door lock device discloses a door lock device that has a simple structure and can be operated manually.

As an automatic door lock device, Korean Patent Registration No. 10-2356893 (Jan. 25, 2022) “Auto-Open Door Lock Device for Home Appliances” patent (hereinafter referred to as “the '893 patent”) describes an auto-open door lock device having a structure in which the door lock is automatically released and the door opens when the operation of a washing machine, dryer, or the like is completed.

However, until now, there has only been discussion about whether to manually or automatically open the door lock when the operation of the device is completed, and it is difficult to find a device that implements a soft door lock that automatically locks the door lock.

Door lock devices attached to drum washing machines, dishwashers, and the like are mostly divided into a fully locked state and a closed state. In particular, the state in which the door is closed is a state in which a rotating cam is caught on a hook, and in the aforementioned auto-open door lock device, the cam automatically rotates to create a state in which the door opens.

In this case, the user closes the door with force, applying shock to the door lock device, which can cause malfunction. Furthermore, when the door lock is not fully locked, the washing machine, dishwasher, or the like may operate, which can cause water leakage or malfunction.

Therefore, the function of automatically closing and locking the door must be mounted on the device as an essential function of the door lock device.

### DETAILED DESCRIPTION

### Technical Subject

An object of the present invention is to provide a door lock device capable of soft closing.

### Technical Solution

A door lock device according to an embodiment of the present invention relates to a door lock device including a body cover having a space formed therein and a motor installed inside the body cover to provide driving force, comprising: a locker that is coupled to or separated from a hook introduced from the outside through rotation; a locker shaft having one end connected to the locker and formed at the rotation center of the locker; a rack slide that provides rotational force of the motor (20) to the rotary; a pinion gear that transmits the rotational force of the motor (20) to the rack slide; a damper connected to one end of the locker shaft; a side plate connected to both ends of the locker shaft; a release cam in which the locker is accommodated, one side of which is penetrated by one end of the locker shaft to be connected to the damper, and the other side of which is penetrated by the other end of the locker shaft to be connected to the side plate, and which performs arc movement around a rotation axis coupled to the body; a release elastic member accommodated inside the release cam to provide elastic force upward; a rotary that moves the release cam in a direction opposite to the elastic force acting on the release cam by the release elastic member; and a bridge that connects the rack slide and the rotary to each other and rotates the rotary by movement of the rack slide, wherein the side plate includes a first movement track that guides vertical and horizontal movement of the locker shaft, and one side and the other side of the release cam include a second movement track that guides horizontal movement of the locker shaft.

Here, the rack slide includes a track hole, which is a space formed in a predetermined area at one end for the bridge to rotate, and a rack gear that engages with the pinion gear in a predetermined area at the other end.

In addition, the door lock device according to an embodiment of the present invention further includes a slide spring having one end coupled to the body cover and the other end connected to the rack slide to linearly move the rack slide in the locker direction.

In addition, the door lock device according to an embodiment of the present invention further includes a locker lock slide inserted into a lower portion of the rotary to block rotation of the rotary.

Here, the pinion gear includes a first pinion gear and a second pinion gear that share a rotation center and are coupled in a longitudinal direction, and the second pinion gear has gear teeth formed only in a predetermined area of an outer circumferential surface.

Here, the damper includes a damper cover directly connected to the locker shaft and a damper body connected to the damper cover to generate a load.

### EFFECT

The door lock device according to an embodiment of the present invention is capable of soft closing that naturally guides the door to close.

In addition, it is possible to implement a compact size compared to existing door lock devices, which is advantageous for securing space.

In addition, it is possible to reduce the impact applied to the door, thereby reducing the risk of malfunction of the actual door lock.

### BRIEF DESCRIPTION OF DRAWINGS

FIG. 1 is a perspective view of a door lock device according to an embodiment of the present invention.

FIG. 2 is a front view of a door lock device according to an embodiment of the present invention.

FIG. 3 is a perspective view of a damper according to an embodiment of the present invention.

FIG. 4 is a plan view of a door lock device according to an embodiment of the present invention.

FIG. 5 is a cross-sectional view of a door lock device according to an embodiment of the present invention.

FIG. 6 is an exploded cross-sectional view of a door lock device according to an embodiment of the present invention.

### MODE

Specific structural or functional descriptions of embodiments according to the concept of the present invention disclosed in this specification are merely illustrated for the purpose of explaining the embodiments according to the concept of the present invention, and the embodiments according to the concept of the present invention may be implemented in various forms and are not limited to the embodiments described in this specification.

Since the embodiments according to the concept of the present invention can apply various changes and have various forms, the embodiments will be illustrated in the drawings and described in detail in this specification. However, this is not intended to limit the embodiments according to the concept of the present invention to specific disclosed forms, but includes all modifications, equivalents, or substitutes included in the spirit and technical scope of the present invention.

Terms such as first or second may be used to describe various components, but the components should not be limited by the terms. The terms are used only for the purpose of distinguishing one component from another component, for example, without departing from the scope of rights according to the concept of the present invention, a first component may be referred to as a second component, and similarly, a second component may also be referred to as a first component.

When a component is referred to as being “connected” or “coupled” to another component, it should be understood that it may be directly connected or coupled to the other component, but other components may exist in between. On the other hand, when a component is referred to as being “directly connected” or “directly coupled” to another component, it should be understood that there are no other components in between. Other expressions describing relationships between components, such as “between” and “directly between” or “adjacent to”and “directly adjacent to,”should be interpreted similarly.

The terminology used in this specification is used only to describe specific embodiments and is not intended to limit the present invention. Singular expressions include plural expressions unless the context clearly indicates otherwise. In this specification, terms such as “comprise” or “have” are intended to designate the presence of features, numbers, steps, operations, components, parts, or combinations thereof described in this specification, and should be understood as not excluding in advance the possibility of the presence or addition of one or more other features, numbers, steps, operations, components, parts, or combinations thereof.

Unless defined otherwise, all terms used herein, including technical or scientific terms, have the same meaning as commonly understood by one of ordinary skill in the art to which the present invention belongs. Terms such as those defined in commonly used dictionaries should be interpreted as having meanings consistent with the meanings in the context of the related art, and unless explicitly defined in this specification, are not interpreted in an ideal or excessively formal sense.

Hereinafter, embodiments of the present invention will be described in detail with reference to the drawings attached to this specification. However, the scope of the patent application is not limited or restricted by these embodiments. The same reference numerals in each drawing indicate the same member.

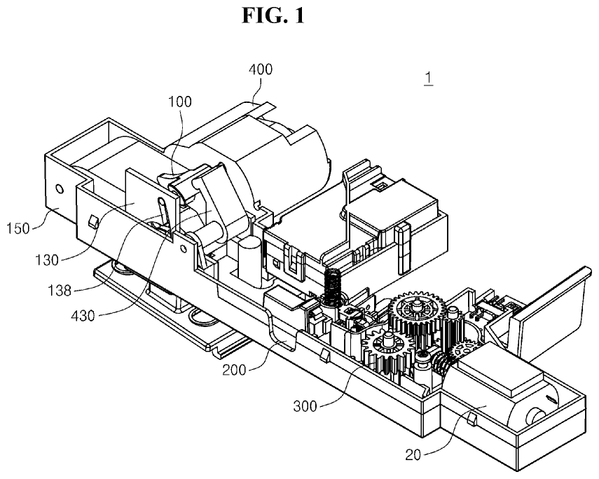

FIG. 1 is a perspective view of a door lock device according to an embodiment of the present invention.

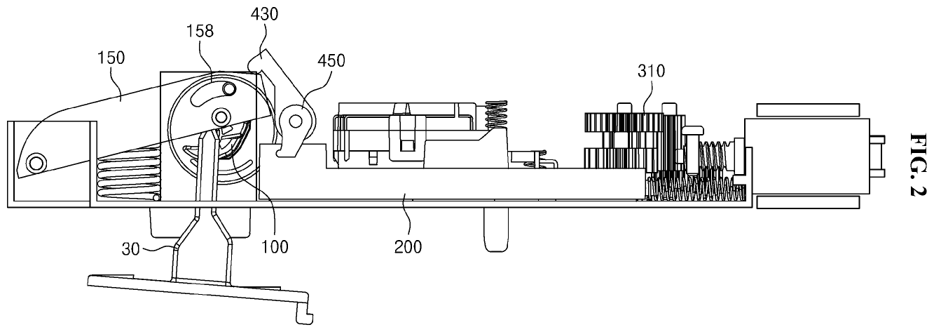

FIG. 2 is a front view of a door lock device according to an embodiment of the present invention.

As shown in FIGS. 1 and 2, the present invention relates to a door lock device (1) including a body cover (10) having a space formed therein and a motor (20) installed inside the body cover (10) to provide driving force, comprising: a locker (100) that is coupled to or separated from a hook (30) introduced from the outside through rotation; a locker shaft (110) having one end connected to the locker (100) and formed at the rotation center of the locker (100); a rack slide (200) that provides rotational force of the motor (20) to a rotary (430); a pinion gear (300) that transmits the rotational force of the motor (20) to the rack slide (200); a damper (400) connected to one end of the locker shaft (110); a side plate (130) coupled to the body cover (10) and connected to both ends of the locker shaft (110); a release cam (150) in which the locker (100) is accommodated, one side of which is penetrated by one end of the locker shaft (110) to be connected to the damper (400), and the other side of which is penetrated by the other end of the locker shaft (110) to be connected to the side plate (130), and which performs arc movement around a rotation axis (151) coupled to the body cover (10); a release elastic member (153) accommodated inside the release cam (150) to provide elastic force upward; a rotary (430) that moves the release cam (150) in a direction opposite to the elastic force acting on the release cam (150) by the release elastic member (153); and a bridge (450) that connects the rack slide (200) and the rotary (430) to each other and rotates the rotary (430) by movement of the rack slide (200), wherein the side plate (130) includes a first movement track (138) that guides vertical and horizontal movement of the locker shaft (110), and one side and the other side of the release cam (150) include a second movement track (158) that guides horizontal movement of the locker shaft (110).

The locker (100) is generally configured to rotate at a predetermined angle to a location where a hook (30) attached to the door of a home appliance is fastened. The locker (100) is a place where the hook (30) is fastened and directly receives a load, and is preferably made of a metal alloy material or plastic material that guarantees rigidity as much as possible. The shape of the locker (100) may be implemented in various ways, and as shown in FIGS. 1 and 2, may be an angular ring shape with one side open.

The locker (100) is designed to rotate by a predetermined angle, and when the fastening portion of the hook (20) flows into the locker (100), the locker (100) rotates to prevent the hook (20) from being separated in the same direction, and as the locker (100) rotates back to the angle at the time of inflow of the hook (20), the hook (20) can be released from engagement.

The locker shaft (110) is coupled to the locker (100). The locker shaft (110) may be formed integrally with the locker (100), or may be formed by being firmly assembled with the locker (100). In particular, the locker shaft (110) may simultaneously perform the function of a rotation axis on which the locker (100) rotates. The locker shaft (110) is preferably made of the same material as the locker (100), but is not necessarily limited thereto, and is made of a material that does not bend firmly. The locker shaft (110) has an elongated pipe shape and is coupled to protrude so as to support the locker (100) centered on the locker (100).

The rack slide (200) transmits the rotational force of the motor (20) to the rotary (430) to be described below, as shown in FIG. 1. The rack slide (200) may be located at the edge of the body cover (10), and is inserted into the body cover (10) in an elongated rod shape to be positioned to enable linear motion.

The rack slide (200) is connected to a slide spring (220) having one end fixed to the body cover (10) to receive tension in the longitudinal direction. This tension is resisted by the rotation of the gear according to the rotation of the motor (20).

As shown in FIG. 2, the rack slide (200) includes a track hole (240), which is a space formed in a predetermined area at one end for the bridge (450) to rotate, and a rack gear (270) that engages with the pinion gear (300) in a predetermined area at the other end.

The pinion gear (300) transmits the rotational force of the motor (20) to the rack slide (200). The pinion gear (300) includes a first pinion gear (310) and a second pinion gear (not shown) that share a rotation center and are coupled in a longitudinal direction, and the second pinion gear may have gear teeth formed only in a predetermined area of an outer circumferential surface.

The rack gear (270) of the rack slide (200) examined above is coupled with the second pinion gear, and the first pinion gear (310) is directly or indirectly connected to the motor (20).

As the motor (20) rotates, the first pinion gear (310) rotates, and at the same time, the second pinion gear also rotates. However, while the second pinion gear rotates with the rack gear (270) and the gear teeth engaged, in a predetermined section without gear teeth, the rack gear (270) is not constrained by the rotational force of the motor (20), enabling the rack slide (200) to be freely transported toward the locker (100).

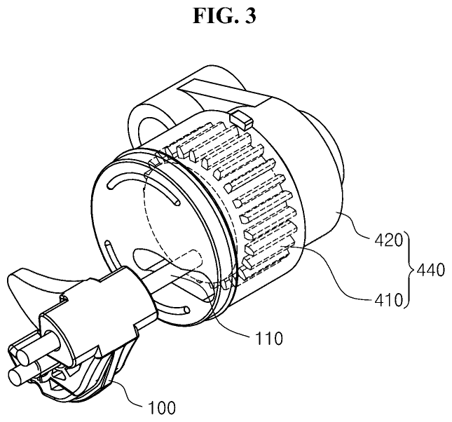

FIG. 3 is a perspective view of a damper according to an embodiment of the present invention.

As shown in FIG. 3, the damper (400) is connected to one end of the locker shaft (110). More specifically, the damper (400) is divided into a damper cover (410) and a damper body (430), and the locker shaft (110) is fixed to the cylindrical damper cover (410). The damper cover (410) is fitted into the damper body (430) with teeth engaged with each other, and as the damper body (430) rotates, rotational load is induced by the silicon or fluid contained therein, acting as a load on sudden movements or impacts.

The side plate (130) is connected to both ends of the locker shaft (110). The side plate (130) is coupled to the body cover (10), and a first movement track (138) is formed on the side plate (130) to allow the locker shaft (110) to move up, down, left, and right, which may be “L”-shaped as shown in FIG. 1.

As shown in FIGS. 1 and 2, the release cam (150) is a rotating member that performs arc movement at a predetermined angle around a rotation axis connected to the body cover (10), and the locker (100) is accommodated therein, and on one side, one end of the locker shaft (110) penetrates to be connected to the side plate (130) and again to the damper (400). On the other side, the other end of the locker shaft (110) penetrates to be connected to the side plate (130).

The release cam (150) is inserted into the inside of the body cover (10), and the release cam (150) itself also has a hollow structure, so the locker (100) and the release elastic member (153) to be described later are accommodated.

The release elastic member (153) accommodated inside the release cam (150) may be an elastic spring, but is not necessarily limited thereto. As shown in FIG. 2, the elastic spring is fixed to the bottom of the body cover (10) and the upper end is attached to the lower surface of the release cam (150) to perform the function of raising the release cam (150).

As shown in FIG. 2, a second movement track (158) is formed on one side and the other side of the release cam (150) to guide the horizontal movement of the locker shaft (110).

The rotary (430) applies a force that moves the release cam (150) in a direction opposite to the elastic force acting on the release cam (150) by the release elastic member (153). As mentioned earlier, the rotary (430) performs a rotational motion by the movement of the rack slide (200) and performs the function of pressing the release cam (150) from the side opposite to the rotation axis.

The bridge (450) connects the rack slide (200) and the rotary (430) to each other and rotates the rotary (430) by movement of the rack slide (200).

More specifically, one end of the bridge (450) is accommodated in the track hole (240) of the rack slide (200), and as the rack slide (200) moves linearly, the bridge (450) rotates left and right along the track hole (240). The rotary (430) connected to the bridge (450) rotates together to press the release cam (150) downward.

The door lock device (1) according to an embodiment of the present invention further includes a locker lock slide (600) inserted into a lower portion of the rotary (430) to block rotation of the rotary (430).

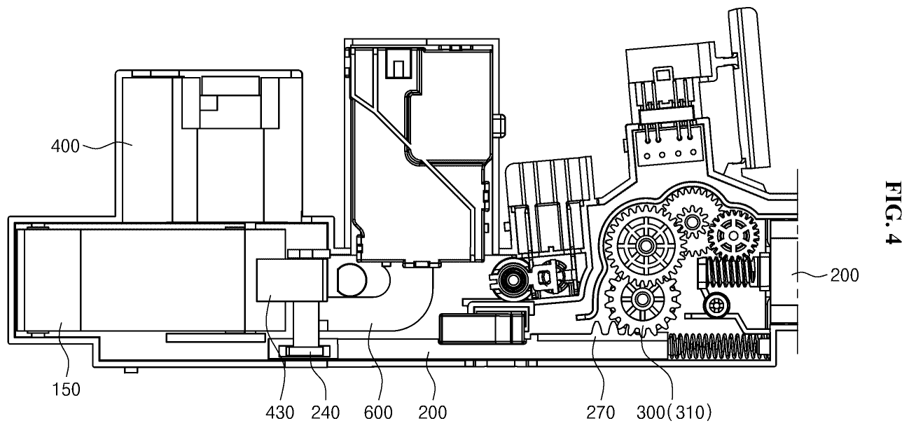

FIG. 4 is a plan view of a door lock device according to an embodiment of the present invention.

The locker lock slide (600) flows into the lower portion of the rotary (430) to prevent the rotary (430) from rotating. That is, a situation occurs where the rotary (430) cannot press the release cam (150), and the locker (100) is maintained in a locked state. On the other hand, when the locker lock slide (600) moves to the right and exits from the lower portion of the rotary (430), the rotary (430) becomes capable of rotating, and as the rack slide (200) moves to the right, the rotary (430) moves counterclockwise by the bridge (450), and when the release cam (150) is pressed, the locker (100) is released from the locked state to become a closed state.

The locker lock slide (600) is operated by a solenoid motor or the like and may be implemented in various forms.

The components of the door lock device (1) according to an embodiment of the present invention have been examined above. Hereinafter, the operating state of the door lock device according to an embodiment of the present invention will be examined through FIGS. 2, 5, and 6.

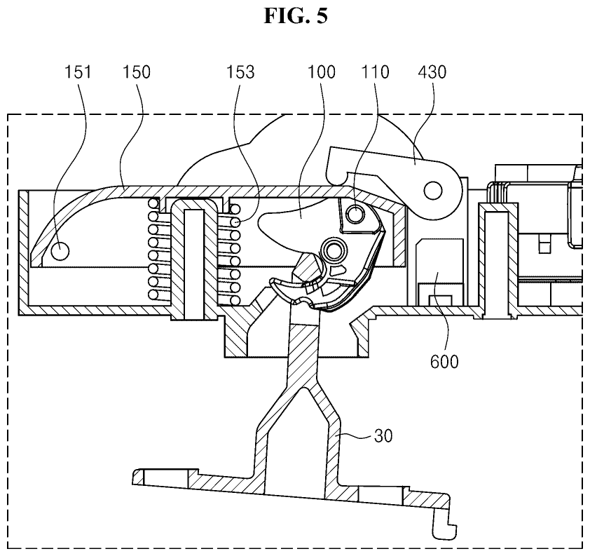

FIG. 5 is a cross-sectional view of a door lock device according to an embodiment of the present invention.

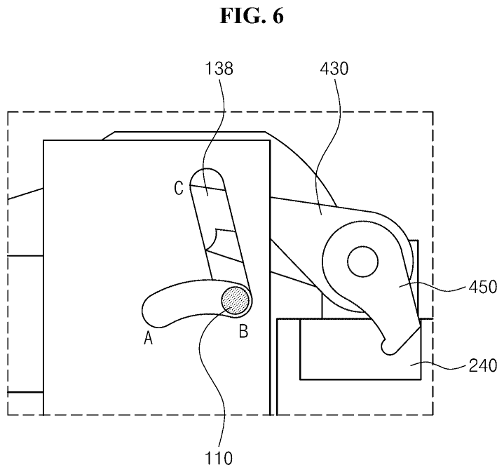

FIG. 6 is an exploded cross-sectional view of a door lock device according to an embodiment of the present invention.

As shown in FIG. 5, when the hook (30) attached to the door flows toward the locker (100), the hook (30) is caught in the ring formed on the locker (100). As the hook (30) caught on the locker (100) pushes in, the locker (100) rotates counterclockwise. When the locker (100) is in a closed state as shown in FIG. 5, the locker shaft (110) is placed at position B of the first movement track (138) of the side plate (130) as shown in FIG. 6. The rotary (430) is pressing the release cam (150).

As the rack slide (200) shown in FIGS. 2 and 5 moves to the right, rotating the bridge (450), and at the same time, the rotary (430) that was pressing the release cam (150) rises, and the release cam (150) also rises. When the release cam (150) rises, the locker shaft (110) is placed at position C of the first movement track (138) shown in FIG. 6.

The power to move from position B to position C is the release elastic member (153). When the release cam (150) rises by the release elastic member (153), it does not rise abruptly, but closes softly by the damper (500) installed on the side.

Finally, the locker lock slide (600) flows into the lower portion of the rotary (430) as shown in FIG. 4 to fix the rotary (430) and prevent the rotary (430) from rotating counterclockwise, thereby fixing the hook (30) in a locked state by being coupled with the locker (100).

The present invention has been described with reference to the embodiments shown in the drawings, but these are merely exemplary, and those of ordinary skill in the art will understand that various modifications and equivalent other embodiments are possible therefrom. For example, even if the described techniques are performed in a different order from the described method, and/or components of the described systems, structures, devices, circuits, etc. are combined or combined in a different form from the described method, or are replaced or substituted by other components or equivalents, appropriate results may be achieved. Therefore, the true technical protection scope of the present invention should be determined by the technical spirit of the appended claims.

What is claimed is:

1. A door lock device comprising a body cover having a space formed therein and a motor installed inside the body cover to provide driving force, the door lock device comprising:
a locker that is coupled to or separated from a hook introduced from the outside through rotation;
a locker shaft having one end connected to the locker and formed at a rotation center of the locker;
a rack slide that provides rotational force of the motor to a rotary;
a pinion gear that transmits the rotational force of the motor to the rack slide;
a damper connected to one end of the locker shaft;
a side plate connected to both ends of the locker shaft;
a release cam in which the locker is accommodated, one side of which is penetrated by one end of the locker shaft to be connected to the damper, and the other side of which is penetrated by the other end of the locker shaft to be connected to the side plate, and which performs arc movement around a rotation axis coupled to the body;
a release elastic member accommodated inside the release cam to provide elastic force upward;
a rotary that moves the release cam in a direction opposite to the elastic force acting on the release cam by the release elastic member; and
a bridge that connects the rack slide and the rotary to each other and rotates the rotary by movement of the rack slide,
wherein the side plate includes a first movement track that guides vertical and horizontal movement of the locker shaft, and one side and the other side of the release cam include a second movement track that guides horizontal movement of the locker shaft.

2. The door lock device of claim 1, wherein the rack slide comprises:
a track hole, which is a space formed in a predetermined area at one end for the bridge to rotate; and
a rack gear that engages with the pinion gear in a predetermined area at the other end.

3. The door lock device of claim 2, further comprising a slide spring having one end coupled to the body cover and the other end connected to the rack slide to linearly move the rack slide in the locker direction.

4. The door lock device of claim 1, further comprising a locker lock slide inserted into a lower portion of the rotary to block rotation of the rotary.

5. The door lock device of claim 1, wherein the pinion gear comprises a first pinion gear and a second pinion gear that share a rotation center and are coupled in a longitudinal direction, and the second pinion gear has gear teeth formed only in a predetermined area of an outer circumferential surface.

6. The door lock device of claim 1, wherein the damper comprises:
a damper cover directly connected to the locker shaft; and
a damper body connected to the damper cover to generate a load.
